(19) United States
(12) Patent Application Publication
(10) Pub. No.: US 2026/0092680 A1
(43) Pub. Date: Apr. 2, 2026

(54) CRYOGEN FILLING APPARATUS

(71) Applicant: MVE Biological Solutions US, LLC, Brentwood, TN (US)

(72) Inventors: David Fitzgerald, Acworth, GA (US); Will Stockdell, Woodstock, GA (US)

(73) Assignee: MVE Biological Solutions US, LLC, Brentwood, TN (US)

(21) Appl. No.: 19/344,254

(22) Filed: Sep. 29, 2025

Related U.S. Application Data
(60) Provisional application No. 63/701,467, filed on Sep. 30, 2024.

(51) Int. Cl. F17C 5/02; F17C 5/00; F17C 13/02; F17C 13/04

(52) U.S. Cl. CPC F17C 5/02; F17C 5/002; F17C 13/025; F17C 13/026; F17C 13/04; F17C 2223/0161; F17C 2225/0161; F17C 2227/04

(57) ABSTRACT

A fill control system and method are provided. The system may include valves connecting a cryogen vessel to a cryogen manifold. The system may detect a cooling of the cryogen manifold caused by filling of another cryogen vessel with cryogen, and responsively initiate its own filling process. Thus, a number and duration of venting instances is reduced. Before filling a cryogen vessel with cryogen, a fill control system may vent filling lines and/or a cryogen manifold to limit introduction of warm fluid into a cryogen vessel. By determining when another fill control system has already initiated venting of the cryogen manifold (indicated by cooling of the cryogen manifold as cryogen flows), a fill control system reduces the amount of venting that it must perform prior to filling its associated cryogen vessel from the cryogen manifold.

### CROSS-REFERENCE TO RELATED APPLICATIONS

This patent application is a non-provisional application that claims priority to U.S. Provisional Patent App. No. 63/701,467 entitled “Cryogen Filling Apparatus” filed Sep. 30, 2024, which is incorporated by reference herein in its entirety.

### FIELD

The present disclosure relates to filling systems, and more specifically, systems for filling multiple vessels with a fluid.

### BACKGROUND

Frequently there are multiple vessels that are desired to be filled with a fluid. For instance, in a facility with multiple vessels containing cryogenic fluid and/or content desired to be maintained at a relatively cold temperature, periodic filling may be desired to replace evaporated or sublimated cryogen. In various embodiments, a central manifold connects to filling lines going to each vessel. Sensors or timers associated with each or multiple of the vessels may trigger filling of the vessel with cryogen from the manifold. However, each filling event is associated with wasted time and wasted cryogen, because often a venting or a purging of warm fluid from the manifold and/or filling lines is desired before the filling begins. For instance, it can be undesirable to dispense a warm fluid into a vessel, so the filling lines and/or manifold may be vented or purged until the cryogen fills sufficiently to reach the vessel for dispensing into the vessel. This costs time and wastes cryogen.

### SUMMARY

A fill control system is disclosed. The fill control system may be for filling a cryogen vessel from a shared cryogen manifold. The system may include a primary inlet tubing. The primary inlet tubing may be connected to the shared cryogen manifold to receive cryogen from the shared cryogen manifold. The system may include an inlet temperature sensor. The inlet temperature sensor may be connected to the primary inlet tubing adjacent to the shared cryogen manifold to measure an inlet temperature of the primary inlet tubing adjacent to the shared cryogen manifold. The system may include a fill valve. The fill valve may be disposed between the primary inlet tubing and a primary outlet tubing connected to the cryogen vessel. The system may include a controller. The controller may be connected to the fill valve and to the inlet temperature sensor. The controller may operate the fill valve to permit cryogen to flow through the primary inlet tubing and the primary outlet tubing from the shared cryogen manifold and into the cryogen vessel in response to the inlet temperature sensor detecting that the inlet temperature has decreased a first threshold temperature amount. The first threshold temperature amount may correspond to a presence of the cryogen flowing in the shared cryogen manifold to fill a different cryogen vessel also connected to the shared cryogen manifold.

A fill control system is disclosed. The fill control system may be for filling a cryogen vessel from a shared cryogen manifold. The system may include a primary inlet tubing. The primary inlet tubing may be connected to the shared cryogen manifold to receive cryogen from the shared cryogen manifold. The system may include an inlet pressure sensor. The inlet pressure sensor may be connected to the primary inlet tubing adjacent to the shared cryogen manifold to measure an inlet pressure of the primary inlet tubing adjacent to the shared cryogen manifold. The system may include a fill valve. The fill valve may be disposed between the primary inlet tubing and a primary outlet tubing connected to the cryogen vessel. The system may include a controller. The controller may be connected to the fill valve and the inlet pressure sensor. The controller may operate the fill valve to permit cryogen to flow through the primary inlet tubing and the primary outlet tubing from the shared cryogen manifold and into the cryogen vessel in response to the fill pressure sensor detecting that the inlet pressure has decreased a first threshold pressure amount. The first threshold pressure amount may correspond to a presence of the cryogen flowing in the shared cryogen manifold to fill a different cryogen vessel also connected to the shared cryogen manifold.

A fill control system is disclosed. The fill control system may be for filling a cryogen vessel from a shared cryogen manifold. The system may include a primary inlet tubing. The primary inlet tubing may be connected to the shared cryogen manifold to receive cryogen from the shared cryogen manifold. The system may include an inlet temperature sensor and/or an inlet pressure sensor. The inlet temperature sensor and/or inlet pressure sensor may be connected to the primary inlet tubing adjacent to the shared cryogen manifold to measure an inlet temperature and/or inlet pressure of the primary inlet tubing adjacent to the shared cryogen manifold. The system may include a fill valve. The fill valve may be disposed between the primary inlet tubing and a primary outlet tubing connected to the cryogen vessel. The system may include a controller. The controller may be connected to the fill valve and at least one of to the inlet temperature sensor and/or to the inlet pressure sensor. The controller may operate the fill valve to permit cryogen to flow through the primary inlet tubing and the primary outlet tubing from the shared cryogen manifold and into the cryogen vessel in response to the inlet temperature sensor detecting that the inlet temperature has decreased a first threshold temperature amount and/or the inlet pressure sensor detecting that the inlet pressure has decreased a first threshold pressure amount. The first threshold temperature amount may correspond to a presence of the cryogen flowing in the shared cryogen manifold to fill a different cryogen vessel also connected to the shared cryogen manifold.

In various instances, the controller may also operate the fill valve to permit cryogen to flow through the primary inlet tubing and the primary outlet tubing from the shared cryogen manifold and into the cryogen vessel in response to the inlet pressure sensor detecting that the inlet pressure has decreased a first threshold pressure amount. The first threshold pressure amount may correspond to a presence of the cryogen flowing in the shared cryogen manifold to fill a different cryogen vessel also connected to the shared cryogen manifold. The controller may also operate the fill valve to permit cryogen to flow through the primary inlet tubing and the primary outlet tubing from the shared cryogen manifold and into the cryogen vessel in response to a combination of the inlet temperature and inlet pressure sensors detecting decreases in the first temperature threshold and/or first pressure threshold amounts. The combination of first threshold temperature and/or first threshold pressure amount may correspond to a presence of the cryogen flowing in the shared cryogen manifold to fill a different cryogen vessel also connected to the shared cryogen manifold.

In various embodiments, the system may include one or more further aspects. For instance, the system may include a master fill valve connecting a cryogen source to the shared cryogen manifold. The master fill valve is operable to permit the cryogen to enter the shared cryogen manifold. The controller may be also connected to the master fill valve to cause the master fill valve to operate.

In various embodiments, a plurality of other controllers corresponding to other fill control systems are attached to other cryogen vessels. Each controller among the other controllers may be able to operate the master fill valve to permit the cryogen to enter the shared cryogen manifold.

In various embodiments, a bypass tubing is connected to the primary inlet tubing between the inlet temperature sensor and the fill valve. A bypass valve is connected to the bypass tubing and openable to vent a content of the primary inlet tubing through the bypass tubing and to a bypass vent.

In various embodiments, the content of the primary inlet tubing is the cryogen. In various embodiments, the content of the primary inlet tubing is a gas that is warmer than the cryogen.

The controller may further operate the bypass valve immediately preceding the operating the fill valve to permit the cryogen to flow. The operating the bypass valve may include further aspects. For instance, the operating may include opening the bypass valve until a bypass temperature sensor connected to the bypass tubing detects that a bypass temperature of the bypass tubing is within a second threshold temperature amount of the inlet temperature. The operating may include closing the bypass valve in response to the bypass temperature sensor detecting that the bypass temperature of the bypass tubbing is within the second threshold temperature amount of the inlet temperature.

The controller may further operate the bypass valve immediately preceding the operating the fill valve to permit the cryogen to flow. The operating the bypass valve may include one or more further aspects. The operating may include opening the bypass valve until the controller determines that a predetermined period of time has elapsed. The operating may include closing the bypass valve in response to the predetermined period of time having elapsed.

A cryogen vessel management system is disclosed. The system may include a first fill control system for filling the first cryogen vessel with a cryogen. The first fill control system may be connected between the first cryogen vessel and a shared cryogen manifold to selectively permit the cryogen to flow from the shared cryogen manifold into the first cryogen vessel to fill the first cryogen vessel to a first cryogen vessel cryogen volume. The system may include a second fill control system for filling the second cryogen vessel. The second fill control system may be connected between the second cryogen vessel and the shared cryogen manifold to selectively permit the cryogen to flow from the shared cryogen manifold into the second cryogen vessel to fill the second cryogen vessel to a second cryogen vessel cryogen volume. The first fill control system may selectively connect the first cryogen vessel to the shared cryogen manifold to permit cryogen to flow from the shared cryogen manifold into the first cryogen vessel in response to a first inlet temperature sensor connected to a first primary inlet tubing of the first fill control system detecting a temperature drop of the shared cryogen manifold corresponding to a preceding flowing of cryogen in the shared cryogen manifold to fill the second cryogen vessel.

A cryogen vessel management system is disclosed. The system may include a first fill control system for filling the first cryogen vessel with a cryogen. The first fill control system may be connected between the first cryogen vessel and a shared cryogen manifold to selectively permit the cryogen to flow from the shared cryogen manifold into the first cryogen vessel to fill the first cryogen vessel to a first cryogen vessel cryogen volume. The system may include a second fill control system for filling the second cryogen vessel. The second fill control system may be connected between the second cryogen vessel and the shared cryogen manifold to selectively permit the cryogen to flow from the shared cryogen manifold into the second cryogen vessel to fill the second cryogen vessel to a second cryogen vessel cryogen volume. The first fill control system may selectively connect the first cryogen vessel to the shared cryogen manifold to permit cryogen to flow from the shared cryogen manifold into the first cryogen vessel in response to a first inlet pressure sensor connected to a first primary inlet tubing of the first fill control system detecting a pressure drop of the shared cryogen manifold corresponding to a preceding flowing of cryogen in the shared cryogen manifold to fill the second cryogen vessel.

A cryogen vessel management system is disclosed. The system may include a first fill control system for filling the first cryogen vessel with a cryogen. The first fill control system may be connected between the first cryogen vessel and a shared cryogen manifold to selectively permit the cryogen to flow from the shared cryogen manifold into the first cryogen vessel to fill the first cryogen vessel to a first cryogen vessel cryogen volume. The system may include a second fill control system for filling the second cryogen vessel. The second fill control system may be connected between the second cryogen vessel and the shared cryogen manifold to selectively permit the cryogen to flow from the shared cryogen manifold into the second cryogen vessel to fill the second cryogen vessel to a second cryogen vessel cryogen volume. The first fill control system may selectively connect the first cryogen vessel to the shared cryogen manifold to permit cryogen to flow from the shared cryogen manifold into the first cryogen vessel in response to a first inlet temperature sensor and/or first inlet pressure sensor connected to a first primary inlet tubing of the first fill control system detecting a temperature drop and/or pressure drop of the shared cryogen manifold corresponding to a preceding flowing of cryogen in the shared cryogen manifold to fill the second cryogen vessel.

The cryogen vessel management system may include a master fill valve. The valve may connect a cryogen source to the shared cryogen manifold and may be operable to permit the cryogen to enter the shared cryogen manifold. A first controller of the first fill control system is connected to the master fill valve to cause the master fill valve to operate.

In various instances, a second controller of the second fill control system is also connected to the master fill valve to cause the master fill valve to operate.

In various instances, each of the first and the second controller is independently operable to cause the master fill valve to operate. The other of the first and the second controller causes a corresponding fill valve of the other of the first and the second controller to operate to open, in response to detecting the temperature drop of the shared cryogen manifold corresponding to the preceding flowing of cryogen in the shared cryogen manifold caused by the operating of the master fill valve.

In various instances, each of the first and the second controller is independently operable to cause the master fill valve to operate. The other of the first and the second controller causes a corresponding fill valve of the other of the first and the second controller to operate to open, in response to detecting the pressure drop of the shared cryogen manifold corresponding to the preceding flowing of cryogen in the shared cryogen manifold caused by the operating of the master fill valve.

In various instances, each of the first and the second controller is independently operable to cause the master fill valve to operate. The other of the first and the second controller causes a corresponding fill valve of the other of the first and the second controller to operate to open, in response to detecting the temperature drop and/or pressure drop of the shared cryogen manifold corresponding to the preceding flowing of cryogen in the shared cryogen manifold caused by the operating of the master fill valve.

The system may include the first inlet temperature sensor connected to the first primary inlet tubing adjacent to the shared cryogen manifold to measure a first inlet temperature of the first primary inlet tubing adjacent to the shared cryogen manifold. The system may include a first controller to calculate the temperature drop based on the first inlet temperature. The system may include a first fill valve disposed between the first primary inlet tubing and a first primary outlet tubing connected to the first cryogen vessel. The first controller operates the first fill valve to permit the cryogen to flow through first primary inlet tubing and the first primary outlet tubing from the shared cryogen manifold and into the first cryogen vessel in response to the temperature drop being equal to or greater than a first threshold temperature amount.

The system may also include the first inlet pressure sensor connected to the first primary inlet tubing adjacent to the shared cryogen manifold to measure a first inlet pressure of the first primary inlet tubing adjacent to the shared cryogen manifold. The system may include a first controller to calculate the pressure drop based on the first inlet pressure. The system may include a first fill valve disposed between the first primary inlet tubing and a first primary outlet tubing connected to the first cryogen vessel. The first controller operates the first fill valve to permit the cryogen to flow through first primary inlet tubing and the first primary outlet tubing from the shared cryogen manifold and into the first cryogen vessel in response to the pressure drop being equal to or greater than a first threshold pressure amount.

In various embodiments, the system may also include a first bypass tubing connected to the first primary inlet tubing between the first inlet temperature sensor and the first fill valve, the first bypass tubing also connected to a first bypass valve openable to vent a content of the first primary inlet tubing to a first bypass vent.

In various embodiments, the content of the first primary inlet tubing is the cryogen. In various embodiments, the content of the first primary inlet tubing is a gas that is warmer than the cryogen.

In various embodiments, the first controller further operates the first bypass valve immediately preceding the operating the first fill valve to permit the cryogen to flow. The operating the first bypass valve may include various aspects. For instance, the operating may include opening the first bypass valve until a first bypass temperature sensor connected to the first bypass tubing detects that a first bypass temperature of the first bypass tubing is within a second threshold temperature amount of the first inlet temperature. The operating may include closing the first bypass valve in response to the first bypass temperature sensor detecting that the first bypass temperature of the first bypass tubing is within the second threshold temperature amount of the first inlet temperature.

In various embodiments, the first controller further operates the first bypass valve immediately preceding the operating the first fill valve to permit the cryogen to flow. The operating the first bypass valve may include aspects. For instance, the operating may include opening the first bypass valve until the first controller determines that a predetermined period of time has elapsed. The operating may include closing the first bypass valve in response to the predetermined period of time having elapsed.

A method is provided. The method is a method of filling control for filling cryogen vessels from a shared cryogen manifold by a fill control system. The fill control system may include (1) a primary inlet tubing connected to a shared cryogen manifold to receive cryogen from the shared cryogen manifold, (2) an inlet temperature sensor connected to the primary inlet tubing adjacent to the shared cryogen manifold to measure an inlet temperature of the primary inlet tubing adjacent to the shared cryogen manifold, (3) an inlet pressure sensor connected to the primary inlet tubing adjacent to the shared cryogen manifold to measure an inlet pressure of the primary inlet tubing adjacent to the shared cryogen manifold, (4) a fill valve disposed between the primary inlet tubing and a primary outlet tubing connected to the cryogen vessel, (5) and a controller connected to the fill valve and to the inlet temperature sensor. The method may include various steps. The method may include detecting, by the inlet temperature sensor, that the inlet temperature has decreased a first threshold temperature amount. The method may include detecting, by the inlet pressure sensor, that the inlet pressure has decreased a first threshold pressure amount. The method may include operating, by the controller and in response to the detecting of temperature and/or pressure, the fill valve to permit cryogen to flow through the primary inlet tubing and the primary outlet tubing from the shared cryogen manifold and into the cryogen vessel. In various embodiments, the first threshold temperature and/or first threshold pressure amount(s) correspond(s) to a presence of the cryogen flowing in the shared cryogen manifold to fill a different cryogen vessel also connected to the shared cryogen manifold.

In various embodiments of the method, the system may also include a master fill valve that connects a cryogen source to the shared cryogen manifold. The method may include operating, by a further controller of a further fill control system associated with a further cryogen vessel, the master fill valve connecting the cryogen source to the shared cryogen manifold. The method may include permitting, by the master fill valve and in response to the operating, the cryogen to enter the shared cryogen manifold. The decreasing of the inlet temperature the first threshold temperature amount and/or the decreasing of the inlet pressure the first threshold pressure amount may be in response to the cryogen entering the shared cryogen manifold.

A fill control system is provided for filling a cryogen vessel from a shared cryogen manifold. The fill control system may include a primary inlet tubing connected to the shared cryogen manifold to receive cryogen from the shared cryogen manifold. The fill control system may include an inlet pressure sensor connected to the primary inlet tubing adjacent to the shared cryogen manifold to measure an inlet pressure of the primary inlet tubing adjacent to the shared cryogen manifold. The fill control system may include a fill valve disposed between the primary inlet tubing and a primary outlet tubing connected to the cryogen vessel. The fill control system may include a controller connected to the fill valve and to the inlet pressure sensor. The controller operates the fill valve to permit cryogen to flow through the primary inlet tubing and the primary outlet tubing from the shared cryogen manifold and into the cryogen vessel in response to the inlet pressure sensor detecting that the inlet pressure has decreased a first threshold pressure amount. The first threshold pressure amount corresponds to a presence of the cryogen flowing in the shared cryogen manifold to fill a different cryogen vessel also connected to the shared cryogen manifold.

A cryogen vessel management system is provided. The system may include a first fill control system for filling a first cryogen vessel with a cryogen. The fill control system may be connected between the first cryogen vessel and a shared cryogen manifold to selectively permit the cryogen to flow from the shared cryogen manifold into the first cryogen vessel to fill the first cryogen vessel to a first cryogen vessel cryogen volume. The system may include a second fill control system for filling a second cryogen vessel. The second fill control system may be connected between the second cryogen vessel and the shared cryogen manifold to selectively permit the cryogen to flow from the shared cryogen manifold into the second cryogen vessel to fill the second cryogen vessel to a second cryogen vessel cryogen volume. The first fill control system selectively connects the first cryogen vessel to the shared cryogen manifold to permit cryogen to flow from the shared cryogen manifold into the first cryogen vessel in response to a first inlet pressure sensor connected to a first primary inlet tubing of the first fill control system detecting a pressure drop of the shared cryogen manifold correspond to a preceding flowing of cryogen in the shared cryogen manifold to fill the second cryogen vessel.

A method is provided. The method may be a method of filling control for filling cryogen vessels from a shared cryogen manifold by a fill control system. The fill control system may include (1) a primary inlet tubing connected to the shared cryogen manifold to receive cryogen from the shared cryogen manifold, (2) an inlet pressure sensor connected to the primary inlet tubing adjacent to the shared cryogen manifold to measure an inlet pressure of the primary inlet tubing adjacent to the shared cryogen manifold, (3) a fill valve disposed between the primary inlet tubing and a primary outlet tubing connected to a cryogen vessel, and (4) and a controller connected to the fill valve and to the inlet pressure sensor. The method may include detecting, by the inlet pressure sensor, that the inlet pressure has decreased a first threshold pressure amount. The method may include operating, by the controller and in response to the detecting, the fill valve to permit cryogen to flow through the primary inlet tubing and the primary outlet tubing from the shared cryogen manifold and into the cryogen vessel. The first threshold pressure amount corresponds to a presence of the cryogen flowing in the shared cryogen manifold to fill a different cryogen vessel also connected to the shared cryogen manifold.

The forgoing features and elements may be combined in various combinations without exclusivity, unless expressly indicated herein otherwise. These features and elements as well as the operation of the disclosed embodiments will become more apparent considering the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosures, however, may best be obtained by referring to the detailed description and claims when considered in connection with the drawing figures, wherein like numerals denote like elements.

FIG. 1 illustrates a block diagram of a cryogen vessel management system that includes a plurality of fill control systems, in accordance with various embodiments;

FIG. 2A illustrates a block diagram of a fill control system connected to a cryogen manifold of a cryogen vessel management system and connected to a cryogen vessel, in accordance with various embodiments;

FIG. 2B illustrates a diagram of a practical example embodiment of the fill control system, in accordance with various embodiments;

FIG. 3 illustrates a method of filling one or more cryogen vessels, in accordance with various embodiments;

FIG. 4A illustrates a method of detecting a fill state for one or more cryogen vessels, the method involving temperature sensing, in accordance with various embodiments;

FIG. 4B illustrates a method of detecting a fill state for one or more cryogen vessels, the method involving pressure sensing, in accordance with various embodiments;

FIG. 4C illustrates a further method of detecting a fill state for one or more cryogen vessels and involving pressure sensing, in accordance with various embodiments;

FIG. 5A illustrates an example method of filling control for filling cryogen vessels from a shared cryogen manifold by a fill control system, the method involving temperature sensing, in accordance with various embodiments;

FIG. 5B also illustrates an example method of filling control for filling cryogen vessels from a shared cryogen manifold by a fill control system, the method also involving temperature sensing, in accordance with various embodiments.

FIG. 5C illustrates an example method of filling control for filling cryogen vessels from a shared cryogen manifold by a fill control system, the method involving pressure sensing, in accordance with various embodiments; and

FIG. 5D also illustrates an example method of filling control for filling cryogen vessels from a shared cryogen manifold by a fill control system, the method involving pressure sensing, in accordance with various embodiments.

### DETAILED DESCRIPTION

The detailed description of exemplary embodiments herein refers to the accompanying drawings, which show exemplary embodiments by way of illustration and their best mode. While these exemplary embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option.

Frequently there are multiple vessels that are desired to be filled with a fluid. For instance, in a facility with multiple vessels containing cryogenic fluid and/or content desired to be maintained at a relatively cold temperature, periodic filling may be desired to replace evaporated or sublimated cryogen. In various embodiments, a central manifold connects to filling lines going to each vessel. A sensor or timer associated with each or multiple of the vessels may trigger filling of the vessel with cryogen from the manifold. However, each filling event is associated with wasted time and wasted cryogen, because often a venting or a purging of warm fluid from the manifold and/or filling lines is desired before the filling begins. For instance, it can be undesirable to dispense a warm fluid into a vessel, so the filling lines and/or manifold may be vented or purged until the cryogen fills sufficiently to reach the vessel for dispensing into the vessel. This costs time and wastes cryogen.

This disclosure includes various systems and methods to address these challenges. For instance, this disclosure includes a cryogen filling apparatus that causes multiple cryogen vessels to fill in parallel. When a sensor on a cryogen vessel determines that the cryogen vessel needs to be at least partially filled with cryogen, a system associated with the cryogen vessel operates to accept cryogen from a cryogen manifold. However, systems associated with other cryogen vessels attached to the same cryogen manifold can independently, and without communicating to the first system, determine that a filling event is occurring somewhere on the manifold and separately operate to at least partially fill their own respective associated cryogen vessels, so that time consuming or otherwise wasteful venting events are reduced. Rather than each vessel independently first causing a venting and then a filling, the systems on each vessel may detect when a filling event is occurring, and vent and fill at the same time, so that there are fewer venting events and fewer sequential filling events, as multiple vessels fill simultaneously.

For instance, while the discussion will proceed with greater detail below, each vessel may have a series of associated valves that may be selectively operable by a controller to vent a filling line and/or a cryogen manifold, and then when venting is complete, direct cryogen from the cryogen manifold through the filling line into the vessel. Each vessel may also have a temperature sensor connected to the filling line near to the cryogen manifold. The temperature sensor may detect when a temperature of the filling line near to the cryogen manifold is decreasing. This decreasing may indicate that the cryogen manifold is filling with a cold cryogen. For instance, if a different system associated with a different vessel is venting the cryogen manifold and the cryogen manifold is filling with cryogen, the temperature sensor may detect a decreasing temperature. The temperature sensors detecting this decrease may in cooperation with a controller opportunistically initiate a parallel venting and/or filling process for their own cryogen vessels, so that the initial venting event not only purges warm gas and/or fluid for the initial cryogen vessel initiating a filling event, but for all other cryogen vessels, which may then opportunistically fill with cryogen in parallel. In this manner, the instances that each cryogen vessel and its associated filling system needs to separately command its own venting of the cryogen manifold are reduced and such venting events are shared by multiple filling events of multiple filling systems associated with multiple cryogen vessels.

Each vessel may also (or in lieu of the temperature sensor) have a pressure sensor connected to the filling line near to the cryogen manifold. The pressure sensor may detect when a pressure of the filling line near to the cryogen manifold is decreasing. This decreasing may indicate that the cryogen manifold is filling with a cold cryogen. For instance, if a different system associated with a different vessel is venting the cryogen manifold and the cryogen manifold is filling with cryogen, the pressure sensor may detect a decreasing pressure. The pressure sensors detecting this decrease may in cooperation with a controller, opportunistically initiate a parallel venting and/or filling process for their own cryogen vessels, so that the initial venting event not only purges warm gas and/or fluid for the initial cryogen vessel initiating a filling event, but for all other cryogen vessels, which may then opportunistically fill with cryogen in parallel. In this manner, the instances that each cryogen vessel and its associated filling system needs to separately command its own venting of the cryogen manifold are reduced and such venting events are shared by multiple filling events of multiple filling systems associated with multiple cryogen vessels.

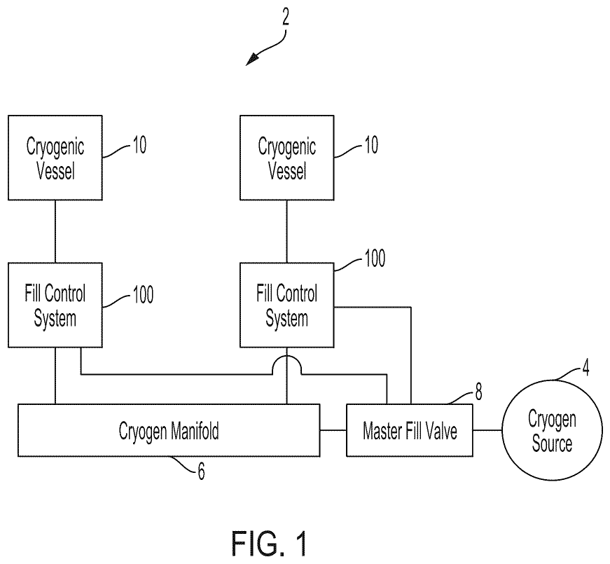

Thus, with reference now to FIG. 1, a cryogen vessel management system 2 is provided. The cryogen vessel management system 2 may be a system of cryogen vessels 10 being filled or maintained at a fill level from a cryogen source 4. The cryogen source 4 may be a cryogen generator, or a larger vessel of cryogenic fluid, or any other source of cryogen. The cryogen source 4 may include a Stirling-acoustic engine to cool and condense cryogen. The cryogen source 4 may be connected to a cryogen manifold 6. The cryogen manifold 6 may include a tubing, a reservoir, one or more pump, one or more valve, and/or other features to conduct cryogen from the cryogen source 4 to various destinations.

The cryogen vessel management system 2 may include one or more master fill valve 8. The master fill valve 8 may be disposed between the cryogen source 4 and the cryogen manifold 6 and may regulate a passage of cryogen from the cryogen source 4 in and to the cryogen manifold 6. The master fill valve 8 may be manually actuated or may be machine actuated such as having an electronically or hydraulically controllable valve or may be both manually actuated and machine actuated. One or more fill control systems 100 may be connected to the master fill valve 8 and may operate the master fill valve 8.

The cryogen vessel management system 2 may include one or more fill control system 100. For instance, a fill control system 100 may be connected between the cryogen manifold 6 and a cryogen vessel 10 and may be operable to selectively permit flow of cryogen from the cryogen manifold 6 to the cryogen vessel 10 and may also be operable to selectively vent a filling line between the cryogen vessel 10 and the cryogen manifold 6 and/or to selectively vent the cryogen manifold 6 such as to purge unwanted warm air or other fluid prior to filling of the cryogen vessel 10 with cryogen from the cryogen manifold 6.

FIG. 1 illustrates a cryogen manifold 6 connected to two cryogen vessels 10 via two fill control systems 100, though any number of cryogen vessels 10 and fill control systems 100 may be provided. Moreover, in some embodiments, a subset of cryogen vessels 10 may share a shared fill control system 100.

In various embodiments, the cryogen vessels 10 may include dewars, cryogenic freezers, flasks, shippers for shipping materials in a refrigerated and/or cryogenic environment, and/or any other container suitable for containing a fluid. Moreover, while reference is made to cryogen throughout, one may appreciate that the fluid may be a fluid at other than cryogenic temperatures. For instance, rather than being a cryogen, the fluid may be a fluid at a dry ice temperature (e.g., negative 80 degrees Celsius) and/or at a water ice temperature (e.g., zero degrees Celsius) and/or any other temperature as desired. Furthermore, the fluid may be a fluid at an elevated temperature, such as warm water, steam, molten salt(s), or other fluids. For instance, the fluid may be a molten salt including fluorine, chlorine, lithium, mixtures such as eutectic or approximately eutectic mixtures and/or the like. For fluids of elevated temperature, references to a temperature or pressure drop herein may be instead a reference to a temperature or pressure increase, in some instances, and vis-a-versa.

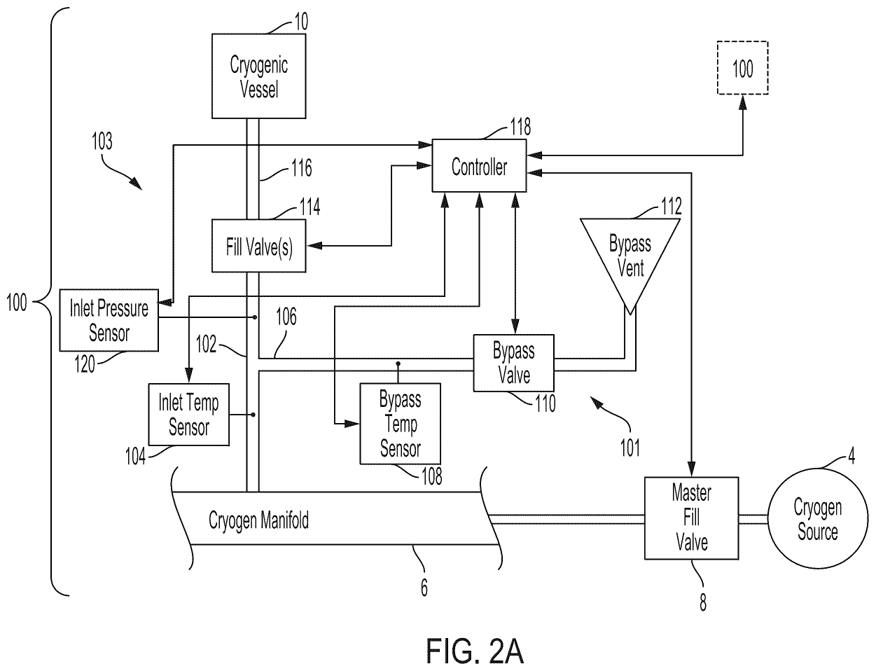

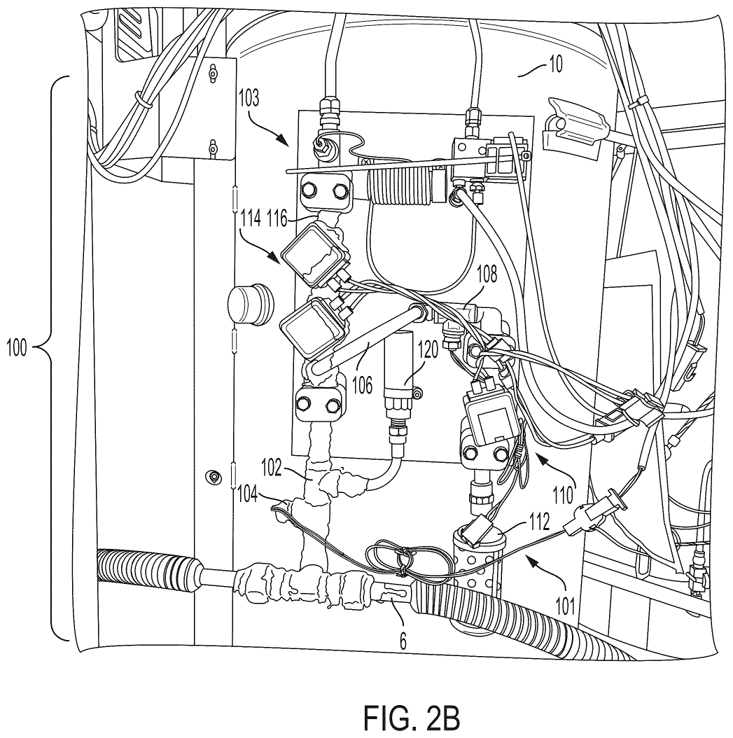

Turning attention now to FIGS. 2A and 2B, an example embodiment of a fill control system 100 is provided. The fill control system 100 comprises a combination of aspects configured to selectively direct a cryogen from a cryogen manifold 6 and into a cryogen vessel 4 or to vent the cryogen manifold 6 and/or fill lines of the fill control system 100.

In various embodiments, the fill control system 100 may include a primary inlet tubing 102. The primary inlet tubing 102 may comprise a tubing connecting a cryogen manifold 6 to a fill valve 114. The tubing may be any structure to facilitate conducting (e.g., flowing) of the fluid from the cryogen manifold 6 to the fill valve 114. In various embodiments, the primary inlet tubing 102 is a pipe.

An inlet temperature sensor 104 may be connected to the primary inlet tubing 102. In various embodiments, the inlet temperature sensor 104 detects a temperature of the primary inlet tubing 102. In various embodiments, the inlet temperature sensor 104 detects a temperature of a fluid (whether gas or liquid) inside the primary inlet tubing 102. The inlet temperature sensor 104 may be adjacent to the cryogen manifold 6, such as at or near an end of the primary inlet tubing 102 connected to the cryogen manifold 6. As such, the inlet temperature sensor 104 may detect a temperature and/or a temperature change associated with a temperature of and/or a temperature change of the cryogen manifold 6 that is conducted to the inlet temperature sensor 104. In various embodiments, the inlet temperature sensor 104 is a thermistor. The inlet temperature sensor 104 may be a resistance temperature detector (RTD) device. The inlet temperature sensor 104 may be an optical or other temperature detector. The inlet temperature sensor 104 may be disposed separately from physical structures of the primary inlet tubing 102, for instance, the sensor may be an optical sensor directed at the primary inlet tubing 102 or directed at the cryogen manifold 6. Other configurations may be implemented.

An inlet pressure sensor 120 may be connected to the primary inlet tubing 102. In various embodiments, the inlet pressure sensor 120 detects a pressure of the primary inlet tubing 102. In various embodiments, the inlet pressure sensor 120 detects a pressure of a fluid (whether gas or liquid) inside the primary inlet tubing 102. The inlet pressure sensor 120 may be adjacent to the cryogen manifold 6, such as at or near an end of the primary inlet tubing 102 connected to the cryogen manifold 6. As such, the inlet pressure sensor 120 may detect a pressure and/or a pressure change associated with a pressure of and/or a pressure change of the cryogen manifold 6 that is conducted to the inlet pressure sensor 120. In various embodiments, the inlet pressure sensor 120 is a strain gauge. The inlet pressure sensor 120 may be a piezoelectric device. The inlet pressure sensor 120 may be an optical or other pressure detector. The inlet pressure sensor 120 may be disposed separately from physical structures of the primary inlet tubing 102, for instance, the sensor may be an optical sensor directed at the primary inlet tubing 102 or directed at the cryogen manifold 6.

Other configurations may be implemented. Moreover, the inlet pressure sensor 120 may be omitted and an inlet temperature sensor 104 may be provided. In further instances, the inlet pressure sensor 102 is provided and the inlet temperature sensor 104 is omitted. In further instances, both the inlet pressure sensor 120 and the inlet temperatures sensor 104 are provided.

The fill valve 114 may be a valve disposed between the primary inlet tubing 102 and the cryogen vessel 10. In various embodiments, a primary outlet tubing 116 may connect the fill valve 114 to the cryogen vessel 10. The fill valve 114 may be a combination of valves. For instance, a first valve element and a second valve element may be connected in series. In this manner, redundancy may be provided so that a stuck-open valve may be overcome by a closable valve in series therewith. The primary outlet tubing 116 may connect the fill valve 114 to the cryogen vessel 10. Thus, one may say that the fill valve 114 is between the primary inlet tubing 102 and a primary outlet tubing 116, and the primary outlet tubing 116 connects the fill valve 114 to the cryogen vessel 10 while the primary inlet tubing 102 connects the fill valve 114 to the cryogen manifold 6.

The primary outlet tubing 116 may be a tubing. The tubing may be any structure to facilitate conducting (e.g., flowing) of the fluid from the fill valve 114 to the cryogen vessel 10. In various embodiments, the primary outlet tubing 116 is a pipe.

In various embodiments, the primary inlet tubing 102 may thus be said to connect to a filling branch 103 and a venting branch 101. The filling branch 103 comprises structures to facilitate the filling of a cryogen vessel 4 with a cryogen from the cryogen manifold 6. The venting branch 101 may include structures to facilitate venting of various tubing and/or the cryogen manifold 6 prior to filling the cryogen vessel 4 with cryogen. The filling branch 103 may comprise the fill valve 114 and the primary outlet tubing 116. The venting branch 101 may include aspects discussed further below.

In various embodiments, the fill control system 100, and more specifically, the filling branch 103 of the fill control system 100 may include bypass tubing 106. Bypass tubing 106 may include a tubing connecting to the primary inlet tubing 102 and providing an alternative fluid path other than through the fill valve 114. In various embodiments, the bypass tubing 106 connects to a bypass valve 110. The bypass valve 110 may be disposed between the bypass tubing 106 and a bypass vent 112 configured to vent fluid to a surrounding sink, such as an atmosphere or a collection vessel. The bypass valve 110 may be a same type of valve as the fill valve 114. The bypass valve 110 may be a combination of valves. For instance, a first valve element and a second valve element may be connected in series. In this manner, redundancy maybe provided so that a stuck-open valve may be overcome by a closable valve in series therewith.

The venting branch 101 may include a bypass vent 112. The bypass vent 112 may comprise an aperture or series of apertures that release a fluid passing through the bypass valve 110 into an atmosphere or a collection vessel.

The venting branch 101 may also include a bypass temperature sensor 108. A bypass temperature sensor 108 may be a temperature sensor to detect a temperature of the bypass tubing 106. The bypass temperature sensor 108 may detect a temperature of a fluid (whether gas or liquid) inside the bypass tubing 106. The bypass temperature sensor 108 may be adjacent to the bypass valve 110, and/or adjacent to a connection of the bypass tubing 106 to the primary inlet tubing 102. In this manner, the bypass temperature sensor 108 may detect temperature drop associated with passing of cryogen into the bypass valve 110 and bypass vent 112. Thus, the bypass temperature sensor 108 may work to detect when a venting of a warm fluid through the bypass valve 110 is completing and cool fluid, such as cryogen is beginning to be vented. As such, the bypass temperature sensor 108 may operate to determine when to end a venting event because all or substantially all of the warm fluid desired to be vented has already been vented. In further embodiments, the bypass temperature sensor 108 is omitted and the inlet temperature sensor 104 performs a same role as the bypass temperature sensor 108, in addition to detecting when a cryogen manifold 6 is being filled with a cool fluid by another fill control system 100 also attached to the cryogen manifold 6. In various embodiments, the bypass temperature sensor 108 is a thermistor. The bypass temperature sensor 108 may be a resistance temperature detector (RTD) device. The bypass temperature sensor 108 may be an optical or other temperature detector. The bypass temperature sensor 108 may be disposed separately from physical structures of the bypass tubing 106, for instance, the sensor may be an optical sensor directed at the bypass tubing 106 or directed at the bypass vent 112. Other configurations may be implemented.

Finally, the fill control system 100 may include a controller 118. A controller 118 may be a processor and/or a memory operable to receive information from sensors and to provide control instructions to one or more valves. For instance, the controller 118 may be connected to the inlet temperature sensor 104 and/or the bypass temperature sensor 108 to receive a temperature therefrom. The controller 118 may also be connected to the inlet pressure sensor 120 to receive a pressure therefrom. The controller 118 may also be connected to the fill valve 114 and/or the bypass valve 110 to control opening and closing of one or more valve. Moreover, the controller 118 may be in communication with controllers 118 of other fill control systems 100. Finally, the controller 118 may be in communication with a master fill valve 8. The master fill valve 8 may control entry of cryogen from a cryogen source 4 into a cryogen manifold 6.

Having now introduced structural aspects of the system, one may appreciate that a “fill sensor” may be a temperature sensor such as inlet temperature sensor 104 or may be pressure sensor such as an inlet pressure sensor 120, or may be a combination of sensor elements, such as both a temperature sensor element such as an inlet temperature sensor 104 and also a pressure sensor element such as an inlet pressure sensor 120. Thus, reference in the specification, claims, and drawings to a “fill sensor” is a reference to a sensor that could be an inlet temperature sensor 104, or an inlet pressure sensor 120, or a set of both an inlet temperature sensor 104 and an inlet pressure sensor 120, or possibly a different sensor or including a different sensor.

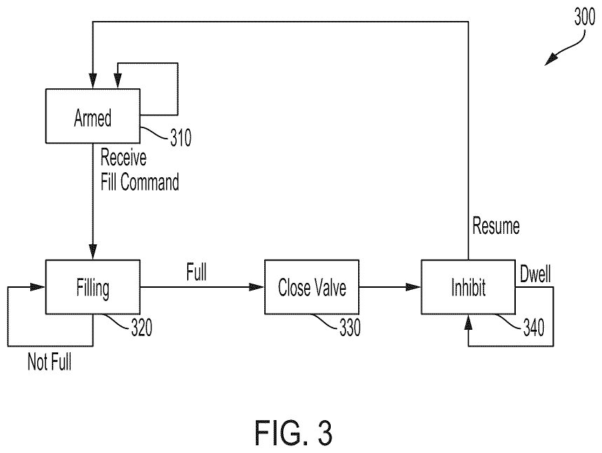

Turning now to FIG. 3, but with continuing reference to features discussed in connection with FIGS. 1, 2A, and 2B, a method of filling one or more cryogen vessels 10 is illustrated. The method 300 may include various steps. Moreover, the method may interoperate with other methods and the systems and devices disclosed herein.

The method 300 may include filling (block 320) of a cryogen vessel 4 with cryogen conducted from a cryogen source 4 into a cryogen manifold 6 and then through the fill control system 100 into the cryogen vessel 10. Filling may continue as long as the cryogen vessel 10 is not full to a desired level. Upon detection that a cryogen vessel 10 is full to a desired level, such as by a sensor, then the method may include closing a valve (block 330). For instance, a controller 118 may direct a fill valve 114 to close, ending the filling of the cryogen vessel 10. The method 300 may proceed to an inhibit stage (block 340), wherein subsequent filling actions are inhibited. This may ameliorate race states. So long as a dwell time has not yet elapsed, the method 300 may remain at the inhibit stage. Upon elapsing of the dwell time, then the method may resume with proceeding to an armed stage (block 310). In an armed stage, a controller 118 may receive and/or issue a fill command, meaning the method may proceed to a filling stage (block 320). In an armed stage, a controller 118 may wait, without action, until such fill command. In various embodiments, a fill command may include a detection, by an inlet temperature sensor 104 that another fill control system 100 has initiated a filling stage (block 320), because the cryogen manifold 6 is cooling, which indicates flowing cryogen therein. In various embodiments, a fill command may include a detection, by an inlet pressure sensor 120 that another fill control system 100 has initiated a filling stage (block 320), because the cryogen manifold 6 pressure has decreased, which indicates flowing cryogen therein. In various embodiments, a fill command may include a detection, by an inlet pressure sensor 120 and/or by an inlet temperature sensor 104 that another fill control system 100 has initiated a filling stage (block 320), because the cryogen manifold 6 pressure has decreased and/or because the cryogen manifold 6 is cooling, which indicates flowing cryogen therein. In various embodiments, a fill command may include a detection, by a fill sensor that another fill control system 100 has initiated a filling stage (block 320), because the cryogen manifold 6 temperature and/or pressure has decreased, which indicates flowing cryogen therein.

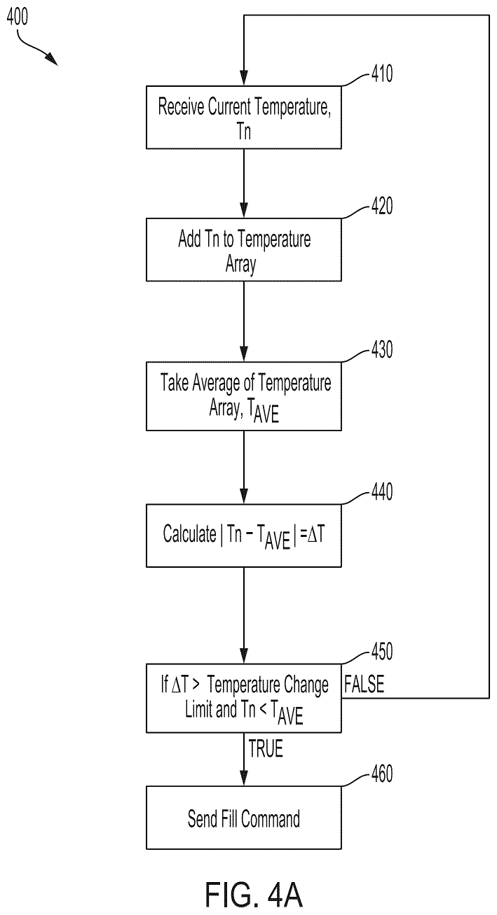

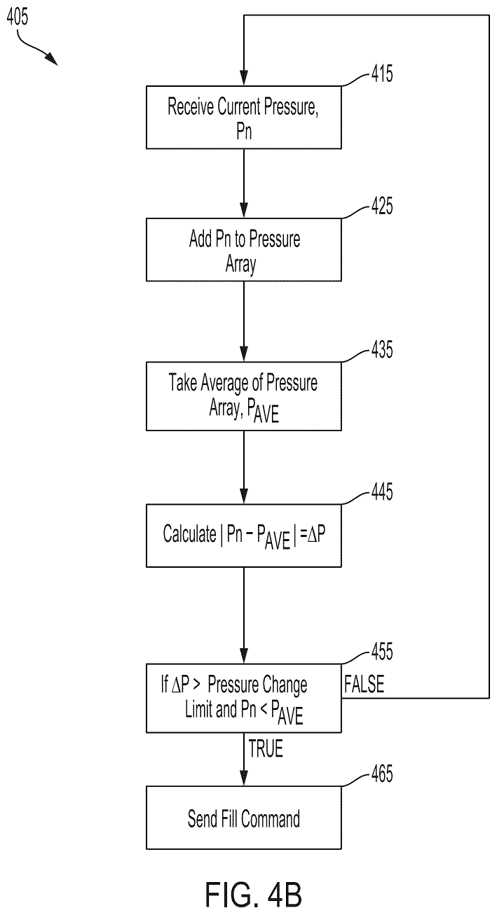

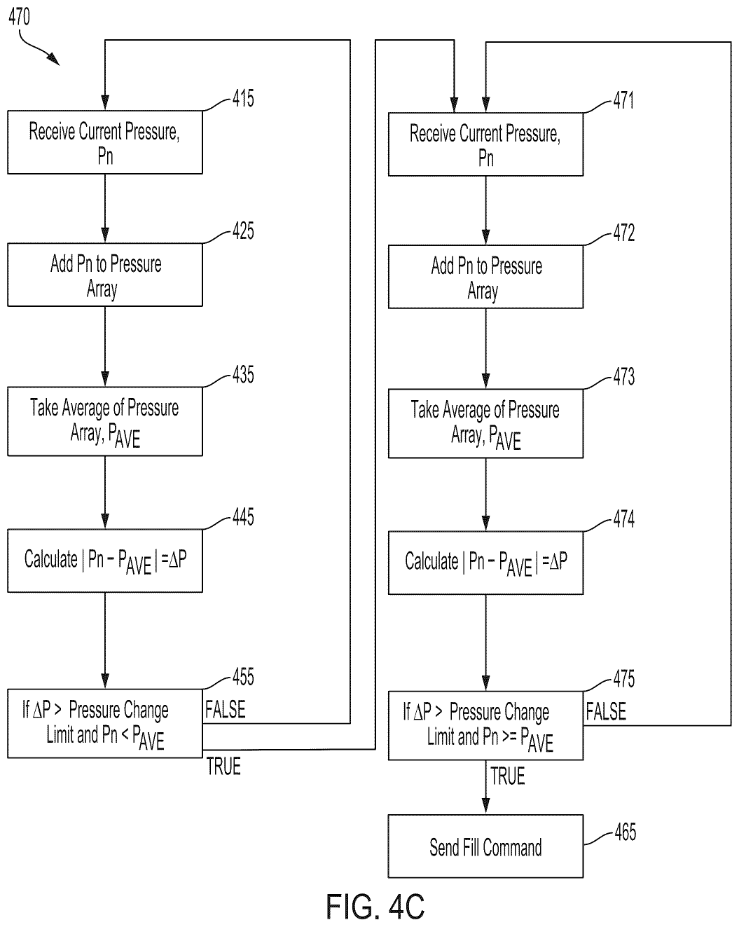

Referring now to FIG. 4A, but with continuing reference to features discussed in connection with FIGS. 1, 2A, 2B, and 3, a method of filling one or more cryogen vessels 10 is disclosed. The method 400 may include various steps that are performed by a fill control system 100, and specifically the controller 118 and sensors (such as an inlet temperature sensor 104 and/or bypass temperature sensor 108) and effectors (such as various valves including a fill valve 114, a bypass valve 110, and optionally, a master fill valve 8).

The method may include receiving, by a controller 118, a current temperature (Tn) from an inlet temperature sensor 104 (block 410). The method may include adding the current temperature (Tn) to a temperature array by the controller 18 (block 420). The temperature array may include a collection of sampled temperatures. The temperature array may be bounded to include a limited collection of sampled temperatures, so that the array includes only relatively recent samples. This facilitates a rolling average calculation. The controller 118 may take an average (Tave) of the temperatures stored in the temperature array (block 430).

The controller 118 may calculate an absolute valve of the difference (delta-T) between the current temperature sample (Tn) and the average (Tave) of the temperatures stored in the temperature array (block 440). If delta-T is greater than a temperature change limit value, and also if the current temperature sample (Tn) is cooler than the average (Tave) of the temperatures stored in the temperature array, then the controller 118 may conclude that a recent and significant temperature drop has occurred, indicative of there being flowing cryogen flowing in the cryogen manifold 6, for the filling of a different cryogen vessel 10 by a different fill control system 100. As such, the controller 118 may send a fill command (block 460). Sending a fill command may include opening a fill valve 114 of a filling branch 103. Sending a fill command may include opening a bypass valve 110 of a venting branch 101. Sending a fill command may include opening a bypass valve 110 of a venting branch 101, closing the bypass valve 110 of the venting branch 101, and opening a fill valve 114 of a filling branch 103.

Referring now to FIG. 4B, but with continuing reference to features discussed in connection with FIGS. 1, 2A, 2B, and 3, a method of filling one or more cryogen vessels 10 is disclosed. The method 400 may include various steps that are performed by a fill control system 100, and specifically the controller 118 and sensors (such as an inlet pressure sensor 120 and/or bypass temperature sensor 108) and effectors (such as various valves including a fill valve 114, a bypass valve 110, and optionally, a master fill valve 8).

The method may include receiving, by a controller 118, a current pressure (Pn) from an inlet pressure sensor 120 (block 415). The method may include adding the current pressure (Pn) to a pressure array by the controller 18 (block 425). The pressure array may include a collection of sampled pressures. The pressure array may be bounded to include a limited collection of sampled pressures, so that the array includes only relatively recent samples. This facilitates a rolling average calculation. The controller 118 may take an average (Pave) of the pressures stored in the pressure array (block 435).

The controller 118 may calculate an absolute value of the difference (delta-P) between the current pressure sample (Pn) and the average (Pave) of the pressures stored in the pressure array (block 445). If delta-P is greater than a pressure change limit value, and also if the current pressure sample (Pn) is lower than the average (Pave) of the pressures stored in the pressure array, then the controller 118 may conclude that a recent and significant pressure drop has occurred, indicative of there being flowing cryogen flowing in the cryogen manifold 6, for the filling of a different cryogen vessel 10 by a different fill control system 100. As such, the controller 118 may send a fill command (block 465). Sending a fill command may include opening a fill valve 114 of a filling branch 103. Sending a fill command may include opening a bypass valve 110 of a venting branch 101. Sending a fill command may include opening a bypass valve 110 of a venting branch 101, closing the bypass valve 110 of the venting branch 101, and opening a fill valve 114 of a filling branch 103.

In various embodiments, rather than sending a fill command at block 465, further processing may be performed. For instance, at block 465, it has been determined by the processor in the preceding block 455 that a recent and significant pressure drop has occurred. In various embodiments, rather than immediately sending a fill command after this detection, processing aspects are performed to check whether a subsequent pressure increase is present, which would indicate a pressure drop associated with there being flowing cryogen flowing in the cryogen manifold 6 followed by a pressure increase as the cryogen source restores the pressure of the flowing cryogen. Because the pressure drop associated with initiation of a fill command is larger if more fill commands are initiated at approximately the same time, this feature ameliorates a likelihood of an undesirably large pressure drop in the manifold. Stated another way, by waiting for a pressure increase before issuing a fill command, the system may limit occurrence of multiple fill commands from multiple controllers in overlapping time, so that the initial pressure drop associated with the beginning of a fill command does not become excessive.

Referring now to FIG. 4C, but with continuing reference to features discussed in connection with FIGS. 1, 2A, 2B, and 3, a method of filling one or more cryogen vessels 10 is disclosed. The method 470 may include various steps that are performed by a fill control system 100, and specifically the controller 118 and sensors (such as an inlet pressure sensor 120 and/or bypass temperature sensor 108) and effectors (such as various valves including a fill valve 114, a bypass valve 110, and optionally, a master fill valve 8).

The method may include receiving, by a controller 118, a current pressure (Pn) from an inlet pressure sensor 120 (block 415). The method may include adding the current pressure (Pn) to a pressure array by the controller 18 (block 425). The pressure array may include a collection of sampled pressures. The pressure array may be bounded to include a limited collection of sampled pressures, so that the array includes only relatively recent samples. This facilitates a rolling average calculation. The controller 118 may take an average (Pave) of the pressures stored in the pressure array (block 435).

The controller 118 may calculate an absolute value of the difference (delta-P) between the current pressure sample (Pn) and the average (Pave) of the pressures stored in the pressure array (block 445). If delta-P is greater than a pressure change limit value, and also if the current pressure sample (Pn) is lower than the average (Pave) of the pressures stored in the pressure array, then the controller 118 may conclude that a recent and significant pressure drop has occurred which may be indicative of there being flowing cryogen flowing in the cryogen manifold 6, for the filling of a different cryogen vessel 10 by a different fill control system 100.

The method may continue with include receiving, by a controller 118, a current pressure (Pn) from an inlet pressure sensor 120 (block 471). The method may include adding the current pressure (Pn) to a pressure array by the controller 18 (block 472). The pressure array may include a collection of sampled pressures. The pressure array may be bounded to include a limited collection of sampled pressures, so that the array includes only relatively recent samples. This facilitates a rolling average calculation. The controller 118 may take an average (Pave) of the pressures stored in the pressure array (block 473). The controller 118 may calculate an absolute value of the difference (delta-P) between the current pressure sample (Pn) and the average (Pave) of the pressures stored in the pressure array (block 474). If delta-P is greater than a pressure change limit value, and also if the current pressure sample (Pn) is greater than or equal to than the average (Pave) of the pressures stored in the pressure array, then the controller 118 may conclude that a recent and significant restoration of pressure has occurred following the prior drop in pressure. This may be indicative of there being flowing cryogen flowing in the system manifold 6 where a transient drop marks the beginning of flow into a volume for filling of a different cryogen vessel 10 by a different fill control system 100 and the restoration of pressure marks quiescence of the flow as the pressure increases and stabilizes with cryogen being sourced from a source and filling into the volume. As such, the controller 118 may send a fill command (block 465). Beneficially, the fill command is sent only after a restoration of pressure, so as to ameliorate a risk of an undesirably large transient drop in pressure resulting from multiple fill control systems 100 sending fill commands in close sequence. Sending a fill command may include opening a fill valve 114 of a filling branch 103. Sending a fill command may include opening a bypass valve 110 of a venting branch 101. Sending a fill command may include opening a bypass valve 110 of a venting branch 101, closing the bypass valve 110 of the venting branch 101, and opening a fill valve 114 of a filling branch 103.

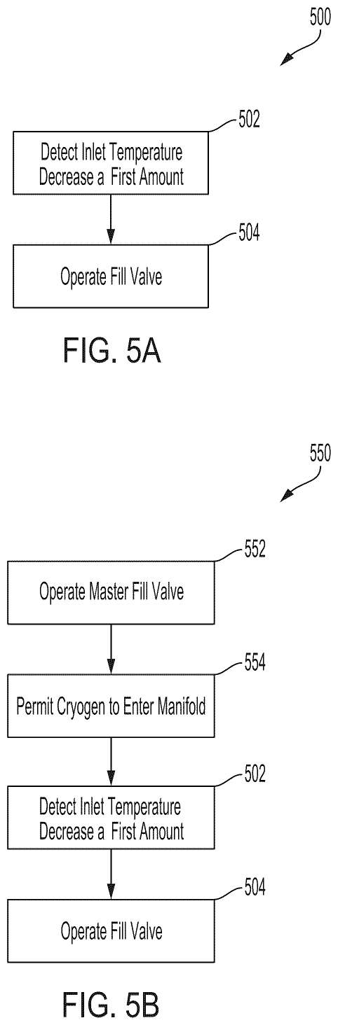

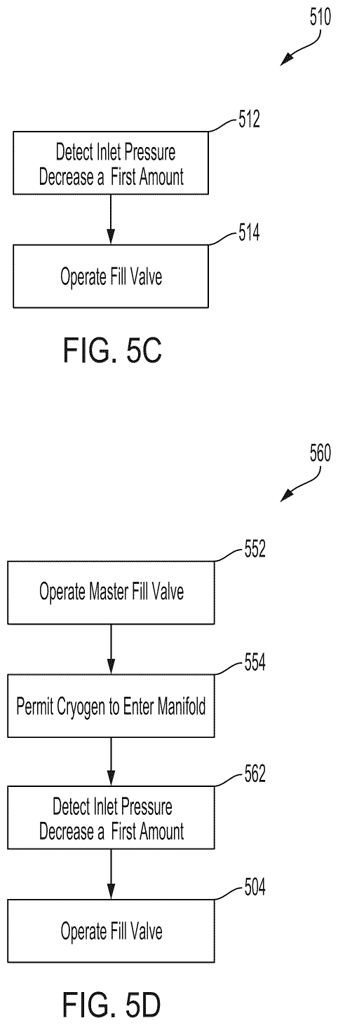

Referring now to FIG. 5A, but with ongoing reference to FIGS. 1-4C, a method of filling control for filling cryogen vessels 10 from a shared cryogen manifold 2 by a fill control system 100 may include one or more aspects. For instance, the method 500 may include detecting an inlet temperature decrease by a first amount (block 502). In response to the inlet temperature decrease by the first amount, the method may include operating a fill valve 114 (block 504).

Referring now to FIG. 5B, but with ongoing reference to FIGS. 1-5A, a method of filling control for filling cryogen vessels 10 from a shared cryogen manifold 2 by a fill control system 100 may include various aspects. The method 550 may include operating a master fill valve 8 (block 552). The method may include permitting a cryogen to enter a manifold, such as a cryogen manifold 6, in response to the operating (block 554). The method may include detecting an inlet temperature decrease by a first amount (block 502). In response to the inlet temperature decrease by the first amount, the method may include operating a fill valve 114 (block 504).

Referring now to FIG. 5C, but with ongoing reference to FIGS. 1-4C, a method of filling control for filling cryogen vessels 10 from a shared cryogen manifold 2 by a fill control system 100 may include one or more aspects. For instance, the method 500 may include detecting an inlet pressure decrease by a first amount (block 502). In response to the inlet pressure decrease by the first amount, the method may include operating a fill valve 114 (block 504).

Referring now to FIG. 5D, but with ongoing reference to FIGS. 1-4C, a method of filling control for filling cryogen vessels 10 from a shared cryogen manifold 2 by a fill control system 100 may include various aspects. The method 560 may include operating a master fill valve 8 (block 552). The method may include permitting a cryogen to enter a manifold, such as a cryogen manifold 6, in response to the operating (block 554). The method may include detecting an inlet pressure decrease by a first amount (block 562). In response to the inlet pressure decrease by the first amount, the method may include operating a fill valve 114 (block 504).

Having introduced various aspects of different systems, and methods, now is a convenient time to discuss a few example implementations of the systems and methods previously described. This discussion may refer to any of the figures from time to time. With reference now to FIGS. 1 through 5D, a fill control system 100 for filling a cryogen vessel 10 from a shared cryogen manifold 2 is provided. The system may include a primary inlet tubing 102. The primary inlet tubing 102 is connected to the shared cryogen manifold 2 to receive cryogen from the shared cryogen manifold 2. The system may include an inlet temperature sensor 104 connected to the primary inlet tubing 102 adjacent to the shared cryogen manifold 2 to measure an inlet temperature of the primary inlet tubing 102 adjacent to the shared cryogen manifold 2. The system may include an inlet pressure sensor 120 connected to the primary inlet tubing 102 adjacent to the shared cryogen manifold 2 to measure an inlet pressure of the primary inlet tubing 102 adjacent to the shared cryogen manifold 2. The system may include both an inlet temperature sensor 104 connected to the primary inlet tubing 102 adjacent to the shared cryogen manifold 2 to measure an inlet temperature of the primary inlet tubing 102 adjacent to the shared cryogen manifold 2 and also an inlet pressure sensor 120 connected to the primary inlet tubing 102 adjacent to the shared cryogen manifold 2 to measure an inlet pressure of the primary inlet tubing 102 adjacent to the shared cryogen manifold 2. The system may include a fill valve 114 disposed between the primary inlet tubing 102 and a primary outlet tubing 116 connected to the cryogen vessel 10. The system may include a controller 118 connected to the fill valve 114 and to the fill temperature sensor 104 and/or the inlet pressure sensor 120. The controller 118 operates the fill valve 114 to permit cryogen to flow through the primary inlet tubing 102 and the primary outlet tubing 116 from the shared cryogen manifold 2 and into the cryogen vessel 10 in response to the fill temperature sensor 104 detecting that the inlet temperature has decreased a first threshold temperature amount and/or the inlet pressure sensor 120 detecting that the inlet pressure has decreased a first threshold pressure amount. The first threshold pressure amount and/or the first threshold temperature amount corresponds to a presence of the cryogen flowing in the shared cryogen manifold 2 to fill a different cryogen vessel 10 also connected to the shared cryogen manifold 2.

In various embodiments, the fill control system 100 includes a master fill valve 8 connecting a cryogen source 4 to the shared cryogen manifold 2. The master fill valve 8 is operable to permit the cryogen to enter the shared cryogen manifold 2. The controller 118 is also connected to the master fill valve 8 to cause the master fill valve 8 to operate. A plurality of other controllers 118 corresponding to other fill control systems 100 are attached to other cryogen vessels 10. Each controller 118 among the other controllers 118 is also able to operate the master fill valve 8 to permit the cryogen to enter the shared cryogen manifold 2.

In various instances, a bypass tubing 106 is connected to the primary inlet tubing 102 between the inlet temperature sensor 104 and the fill valve 114. In various instances, a bypass tubing 106 is connected to the primary inlet tubing 102 between the inlet pressure sensor 120 and the fill valve 114. In various instances, a bypass tubing 106 is connected to the primary inlet tubing 102 between the inlet temperature sensor 104 & the inlet pressure sensor 120 at one side and the fill valve 114 at the other side. A bypass valve 110 is connected to the bypass tubing 106 and openable to vent a content of the primary inlet tubing 102 through the bypass tubing 106 and to a bypass vent 112. The content of the primary inlet tubing 102 may be the cryogen. The content of the primary inlet tubing 102 may be a gas that is warmer than the cryogen.

In various embodiments, the controller 118 further operates the bypass valve 110 immediately preceding operating the fill valve 114 to permit the cryogen to flow. The operating the bypass valve 110 may include opening the bypass valve 110 until a bypass temperature sensor 108 connected to the bypass tubing 106 detects that a bypass temperature of the bypass tubing 106 is within a second threshold temperature amount of the inlet temperature. The operating may include closing the bypass valve 110 in response to the bypass temperature sensor 108 detecting that the bypass temperature of the bypass tubing 106 is within the second threshold temperature amount of the inlet temperature.

In various embodiments, the controller 118 further operates the bypass valve 110 immediately preceding operating the fill valve 114 to permit the cryogen to flow. The operating the bypass valve 110 includes opening the bypass valve 110 until the controller 118 determines that a predetermined period of time has elapsed. The operating the bypass valve 110 includes closing the bypass valve 110 in response to the predetermined period of time having elapsed.

A cryogen vessel management system 2 is provided. The system may include a first fill control system 100 for filling a first cryogen vessel 10 with a cryogen, the first fill control system 100 connected between the first cryogen vessel 10 and a shared cryogen manifold 2 to selectively permit the cryogen to flow from the shared cryogen manifold 2 into the first cryogen vessel 10 to fill the first cryogen vessel 10 to a first cryogen vessel 10 cryogen volume. The system may include a second fill control system 100 for filling a second cryogen vessel 10, the second fill control system 100 connected between the second cryogen vessel 10 and the shared cryogen manifold 2 to selectively permit the cryogen to flow from the shared cryogen manifold 2 into the second cryogen vessel 10 to fill the second cryogen vessel 10 to a second cryogen vessel 10 cryogen volume. The first fill control system 100 selectively connects the first cryogen vessel 10 to the shared cryogen manifold 2 to permit cryogen to flow from the shared cryogen manifold 2 into the first cryogen vessel 10 in response to a first inlet temperature sensor 104 and/or first inlet pressure sensor 120 connected to a first primary inlet tubing 102 of the first fill control system 100 detecting a temperature and/or pressure drop of the shared cryogen manifold 2 correspond to a preceding flowing of cryogen in the shared cryogen manifold 2 to fill the second cryogen vessel 10.

The cryogen vessel management system 2 may include a master fill valve 8 connecting a cryogen source 4 to the shared cryogen manifold 2 and operable to permit the cryogen to enter the shared cryogen manifold 2. A first controller 118 of the first fill control system 100 is connected to the master fill valve 8 to cause the master fill valve 8 to operate. A second controller 118 of the second fill control system 100 may be connected to the master fill valve 8 to cause the master fill valve 8 to operate. Each of the first and the second controller 118 may be independently operable to cause the master fill valve 8 to operate. The other of the first and the second controller 118 may cause a corresponding fill valve 114 of the other of the first and the second controller 118 to operate to open, in response to detecting the temperature and/or pressure drop of the shared cryogen manifold 2 corresponding to the preceding flowing of cryogen in the shared cryogen manifold 2 caused by the operating of the master fill valve 8.

In various embodiments, the first fill control system 100 includes the first inlet temperature sensor 104 connected to the first primary inlet tubing 102 adjacent to the shared cryogen manifold 2 to measure a first inlet temperature of the first primary inlet tubing 102 adjacent to the shared cryogen manifold 2. The first fill control system 100 may include a first controller 118 to calculate the temperature drop based on the first inlet temperature. The first fill control system 100 may include a first fill valve 114 disposed between the first primary inlet tubing 102 and a first primary outlet tubing 116 connected to the first cryogen vessel 10. The first controller 118 may operate the first fill valve 114 to permit the cryogen to flow through the first primary inlet tubing 102 and the first primary outlet tubing 116 from the shared cryogen manifold 2 and into the first cryogen vessel 10 in response to the temperature drop being equal to or greater than a first threshold temperature amount.

In various embodiments, the first fill control system 100 includes the first inlet pressure sensor 120 connected to the first primary inlet tubing 102 adjacent to the shared cryogen manifold 2 to measure a first inlet pressure of the first primary inlet tubing 102 adjacent to the shared cryogen manifold 2. The first fill control system 100 may include a first controller 118 to calculate the pressure drop based on the first inlet pressure. The first fill control system 100 may include a first fill valve 114 disposed between the first primary inlet tubing 102 and a first primary outlet tubing 116 connected to the first cryogen vessel 10. The first controller 118 may operate the first fill valve 114 to permit the cryogen to flow through the first primary inlet tubing 102 and the first primary outlet tubing 116 from the shared cryogen manifold 2 and into the first cryogen vessel 10 in response to the pressure drop being equal to or greater than a first threshold pressure amount.

The cryogen vessel management system 2 may include a first bypass tubing 106 connected to the first primary inlet tubing 102 between the first inlet temperature sensor 104 and/or the first inlet pressure sensor 120 (or both) and the first fill valve 114. The first bypass tubing 106 may be connected to a first bypass valve 110 that is openable to vent a content of the first primary inlet tubing 102 to a first bypass vent 112. The content of the first primary inlet tubing 102 may be the cryogen. The content of the first primary inlet tubing 102 may be a gas that is warmer than the cryogen.

The first controller 118 may further operate the first bypass valve 110 immediately preceding the operating the first fill valve 114 to permit the cryogen to flow. The operating the first bypass valve 110 may include opening the first bypass valve 110 until a first bypass temperature sensor 108 connected to the first bypass tubing 106 detects that a first bypass temperature of the first bypass tubing 106 is within a second threshold temperature amount of the first inlet temperature. The operating may include closing the first bypass valve 110 in response to the first bypass temperature sensor 108 detecting that the first bypass temperature of the first bypass tubing 106 is within the second threshold temperature amount of the first inlet temperature.

In various embodiments, the first controller 118 further operates the first bypass valve 110 immediately preceding the operating the first fill valve 114 to permit the cryogen to flow. The operating the first bypass valve 110 includes opening the first bypass valve 110 until the first controller 118 determines that a predetermined period of time has elapsed. The operating the first bypass valve 110 includes closing the first bypass valve 110 in response to the predetermined period of time having elapsed.

A method of filling control for filling cryogen vessels 10 is provided from a shared cryogen manifold 2 by a fill control system 100, the fill control system 100 comprising (1) a primary inlet tubing 102 connected to the shared cryogen manifold 2 to receive cryogen from the shared cryogen manifold 2, (2) a sensor such as an inlet temperature sensor 104 connected to the primary inlet tubing 102 adjacent to the shared cryogen manifold 2 to measure an inlet temperature of the primary inlet tubing 102 adjacent to the shared cryogen manifold 2, (3) a sensor such as an inlet pressure sensor 104 connected to the primary inlet tubing 102 adjacent to the shared cryogen manifold 2 to measure an inlet pressure of the primary inlet tubing 102 adjacent to the shared cryogen manifold 2, (4) a fill valve 114 disposed between the primary inlet tubing 102 and a primary outlet tubing 116 connected to a cryogen vessel 10, (5) and a controller 118 connected to the fill valve 114, to the inlet temperature sensor 104 and/or to the inlet pressure sensor 120. The method may include detecting, by the inlet temperature sensor 104, that the inlet temperature has decreased a first threshold temperature amount and/or by the inlet pressure sensor 120, that the inlet pressure has decreased a first threshold pressure amount. The method may include operating, by the controller 118 and in response to the detecting, the fill valve 114 to permit cryogen to flow through the primary inlet tubing 102 and the primary outlet tubing 116 from the shared cryogen manifold 2 and into the cryogen vessel 10. The first threshold temperature amount and/or first threshold pressure amount correspond to a presence of the cryogen flowing in the shared cryogen manifold 2 to fill a different cryogen vessel 10 also connected to the shared cryogen manifold 2.

In various instances of the method, a master fill valve 8 connects a cryogen source 4 to the shared cryogen manifold 2. The method includes operating, by a further controller 118 of a further fill control system 100 associated with a further cryogen vessel 10, the master fill valve 8 connecting the cryogen source 4 to the shared cryogen manifold 2. The method includes permitting, by the master fill valve 8 and in response to the operating, the cryogen to enter the shared cryogen manifold 2. The decreasing of the inlet temperature the first threshold temperature amount and/or the inlet pressure the first threshold pressure amount is in response to the cryogen entering the shared cryogen manifold 2.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for. ” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A fill control system for filling a cryogen vessel from a shared cryogen manifold, the fill control system comprising:
a primary inlet tubing connected to the shared cryogen manifold to receive cryogen from the shared cryogen manifold;
an inlet temperature sensor connected to the primary inlet tubing adjacent to the shared cryogen manifold to measure an inlet temperature of the primary inlet tubing adjacent to the shared cryogen manifold;
a fill valve disposed between the primary inlet tubing and a primary outlet tubing connected to the cryogen vessel; and
a controller connected to the fill valve and to the inlet temperature sensor,
wherein the controller operates the fill valve to permit cryogen to flow through the primary inlet tubing and the primary outlet tubing from the shared cryogen manifold and into the cryogen vessel in response to the inlet temperature sensor detecting that the inlet temperature has decreased a first threshold temperature amount, and
wherein the first threshold temperature amount corresponds to a presence of the cryogen flowing in the shared cryogen manifold to fill a different cryogen vessel also connected to the shared cryogen manifold.

2. The fill control system of claim 1, further comprising:
a master fill valve connecting a cryogen source to the shared cryogen manifold,
wherein the master fill valve is operable to permit the cryogen to enter the shared cryogen manifold, and
wherein the controller is also connected to the master fill valve to cause the master fill valve to operate.

3. The fill control system of claim 2,
wherein a plurality of other controllers corresponding to other fill control systems are attached to other cryogen vessels, and
wherein each controller among the other controllers is also able to operate the master fill valve to permit the cryogen to enter the shared cryogen manifold.

4. The fill control system of claim 1, further comprising:
a bypass tubing connected to the primary inlet tubing between the inlet temperature sensor and the fill valve; and
a bypass valve connected to the bypass tubing and openable to vent a content of the primary inlet tubing through the bypass tubing and to a bypass vent.

5. The fill control system of claim 4, wherein the content of the primary inlet tubing comprises the cryogen.

6. The fill control system of claim 4, wherein the content of the primary inlet tubing comprises a gas that is warmer than the cryogen.

7. The fill control system of claim 4,
wherein the controller further operates the bypass valve immediately preceding the operating the fill valve to permit the cryogen to flow, and
wherein the operating the bypass valve comprises:
opening the bypass valve until a bypass temperature sensor connected to the bypass tubing detects that a bypass temperature of the bypass tubing is within a second threshold temperature amount of the inlet temperature, and
closing the bypass valve in response to the bypass temperature sensor detecting that the bypass temperature of the bypass tubing is within the second threshold temperature amount of the inlet temperature.

8. The fill control system of claim 4,
wherein the controller further operates the bypass valve immediately preceding the operating the fill valve to permit the cryogen to flow, and
wherein the operating the bypass valve comprises:
opening the bypass valve until the controller determines that a predetermined period of time has elapsed; and
closing the bypass valve in response to the predetermined period of time having elapsed.

9. A cryogen vessel management system comprising:
a first fill control system for filling a first cryogen vessel with a cryogen, the first fill control system connected between the first cryogen vessel and a shared cryogen manifold to selectively permit the cryogen to flow from the shared cryogen manifold into the first cryogen vessel to fill the first cryogen vessel to a first cryogen vessel cryogen volume; and
a second fill control system for filling a second cryogen vessel, the second fill control system connected between the second cryogen vessel and the shared cryogen manifold to selectively permit the cryogen to flow from the shared cryogen manifold into the second cryogen vessel to fill the second cryogen vessel to a second cryogen vessel cryogen volume,
wherein the first fill control system selectively connects the first cryogen vessel to the shared cryogen manifold to permit cryogen to flow from the shared cryogen manifold into the first cryogen vessel in response to a first inlet temperature sensor connected to a first primary inlet tubing of the first fill control system detecting a temperature drop of the shared cryogen manifold correspond to a preceding flowing of cryogen in the shared cryogen manifold to fill the second cryogen vessel.

10. The cryogen vessel management system of claim 9, further comprising:
a master fill valve connecting a cryogen source to the shared cryogen manifold and operable to permit the cryogen to enter the shared cryogen manifold,
wherein a first controller of the first fill control system is connected to the master fill valve to cause the master fill valve to operate.

11. The cryogen vessel management system of claim 10, wherein a second controller of the second fill control system is also connected to the master fill valve to cause the master fill valve to operate.

12. The cryogen vessel management system of claim 11, wherein each of the first and the second controller is independently operable to cause the master fill valve to operate, and
wherein the other of the first and the second controller causes a corresponding fill valve of the other of the first and the second controller to operate to open, in response to detecting the temperature drop of the shared cryogen manifold corresponding to the preceding flowing of cryogen in the shared cryogen manifold caused by the operating of the master fill valve.

13. The cryogen vessel management system of claim 9, wherein the first fill control system comprises:
the first inlet temperature sensor connected to the first primary inlet tubing adjacent to the shared cryogen manifold to measure a first inlet temperature of the first primary inlet tubing adjacent to the shared cryogen manifold;
a first controller to calculate the temperature drop based on the first inlet temperature; and
a first fill valve disposed between the first primary inlet tubing and a first primary outlet tubing connected to the first cryogen vessel,
wherein the first controller operates the first fill valve to permit the cryogen to flow through the first primary inlet tubing and the first primary outlet tubing from the shared cryogen manifold and into the first cryogen vessel in response to the temperature drop being equal to or greater than a first threshold temperature amount.

14. The cryogen vessel management system of claim 13, further comprising:
a first bypass tubing connected to the first primary inlet tubing between the first inlet temperature sensor and the first fill valve, the first bypass tubing also connected to a first bypass valve that is openable to vent a content of the first primary inlet tubing to a first bypass vent.

15. The cryogen vessel management system of claim 14, wherein the content of the first primary inlet tubing comprises the cryogen.

16. The cryogen vessel management system of claim 14, wherein the content of the first primary inlet tubing comprises a gas that is warmer than the cryogen.

17. The cryogen vessel management system of claim 14,
wherein the first controller further operates the first bypass valve immediately preceding the operating the first fill valve to permit the cryogen to flow, and
wherein the operating the first bypass valve comprises:
opening the first bypass valve until a first bypass temperature sensor connected to the first bypass tubing detects that a first bypass temperature of the first bypass tubing is within a second threshold temperature amount of the first inlet temperature; and
closing the first bypass valve in response to the first bypass temperature sensor detecting that the first bypass temperature of the first bypass tubing is within the second threshold temperature amount of the first inlet temperature.

18. The cryogen vessel management system of claim 14,
wherein the first controller further operates the first bypass valve immediately preceding the operating the first fill valve to permit the cryogen to flow, and
wherein the operating the first bypass valve comprises:
opening the first bypass valve until the first controller determines that a predetermined period of time has elapsed; and
closing the first bypass valve in response to the predetermined period of time having elapsed.

19. A method of filling control for filling cryogen vessels from a shared cryogen manifold by a fill control system, the fill control system comprising (1) a primary inlet tubing connected to the shared cryogen manifold to receive cryogen from the shared cryogen manifold, (2) an inlet temperature sensor connected to the primary inlet tubing adjacent to the shared cryogen manifold to measure an inlet temperature of the primary inlet tubing adjacent to the shared cryogen manifold, (3) a fill valve disposed between the primary inlet tubing and a primary outlet tubing connected to a cryogen vessel, (4) and a controller connected to the fill valve and to the inlet temperature sensor, the method comprising:
detecting, by the inlet temperature sensor, that the inlet temperature has decreased a first threshold temperature amount; and
operating, by the controller and in response to the detecting, the fill valve to permit cryogen to flow through the primary inlet tubing and the primary outlet tubing from the shared cryogen manifold and into the cryogen vessel,
wherein the first threshold temperature amount corresponds to a presence of the cryogen flowing in the shared cryogen manifold to fill a different cryogen vessel also connected to the shared cryogen manifold.

20. The method of claim 19, wherein a master fill valve connects a cryogen source to the shared cryogen manifold, the method further comprising:
operating, by a further controller of a further fill control system associated with a further cryogen vessel, the master fill valve connecting the cryogen source to the shared cryogen manifold; and
permitting, by the master fill valve and in response to the operating, the cryogen to enter the shared cryogen manifold,
wherein the decreasing of the inlet temperature the first threshold temperature amount is in response to the cryogen entering the shared cryogen manifold.

21. A fill control system for filling a cryogen vessel from a shared cryogen manifold, the fill control system comprising:
a primary inlet tubing connected to the shared cryogen manifold to receive cryogen from the shared cryogen manifold;
an inlet pressure sensor connected to the primary inlet tubing adjacent to the shared cryogen manifold to measure an inlet pressure of the primary inlet tubing adjacent to the shared cryogen manifold;
a fill valve disposed between the primary inlet tubing and a primary outlet tubing connected to the cryogen vessel; and
a controller connected to the fill valve and to the inlet pressure sensor,
wherein the controller operates the fill valve to permit cryogen to flow through the primary inlet tubing and the primary outlet tubing from the shared cryogen manifold and into the cryogen vessel in response to the inlet pressure sensor detecting that the inlet pressure has decreased a first threshold pressure amount, and
wherein the first threshold pressure amount corresponds to a presence of the cryogen flowing in the shared cryogen manifold to fill a different cryogen vessel also connected to the shared cryogen manifold.

22. A cryogen vessel management system comprising:
a first fill control system for filling a first cryogen vessel with a cryogen, the first fill control system connected between the first cryogen vessel and a shared cryogen manifold to selectively permit the cryogen to flow from the shared cryogen manifold into the first cryogen vessel to fill the first cryogen vessel to a first cryogen vessel cryogen volume; and
a second fill control system for filling a second cryogen vessel, the second fill control system connected between the second cryogen vessel and the shared cryogen manifold to selectively permit the cryogen to flow from the shared cryogen manifold into the second cryogen vessel to fill the second cryogen vessel to a second cryogen vessel cryogen volume,
wherein the first fill control system selectively connects the first cryogen vessel to the shared cryogen manifold to permit cryogen to flow from the shared cryogen manifold into the first cryogen vessel in response to a first inlet pressure sensor connected to a first primary inlet tubing of the first fill control system detecting a pressure drop of the shared cryogen manifold correspond to a preceding flowing of cryogen in the shared cryogen manifold to fill the second cryogen vessel.

23. A method of filling control for filling cryogen vessels from a shared cryogen manifold by a fill control system, the fill control system comprising (1) a primary inlet tubing connected to the shared cryogen manifold to receive cryogen from the shared cryogen manifold, (2) an inlet pressure sensor connected to the primary inlet tubing adjacent to the shared cryogen manifold to measure an inlet pressure of the primary inlet tubing adjacent to the shared cryogen manifold, (3) a fill valve disposed between the primary inlet tubing and a primary outlet tubing connected to a cryogen vessel, (4) and a controller connected to the fill valve and to the inlet pressure sensor, the method comprising:
detecting, by the inlet pressure sensor, that the inlet pressure has decreased a first threshold pressure amount; and
operating, by the controller and in response to the detecting, the fill valve to permit cryogen to flow through the primary inlet tubing and the primary outlet tubing from the shared cryogen manifold and into the cryogen vessel,
wherein the first threshold pressure amount corresponds to a presence of the cryogen flowing in the shared cryogen manifold to fill a different cryogen vessel also connected to the shared cryogen manifold.
